(19) United States
(12) Patent Application Publication
(10) Pub. No.: US 2018/0005295 A1
(43) Pub. Date: Jan. 4, 2018

(54) SYSTEM AND METHOD FOR PROVIDING FRESHNESS INFORMATION

(71) Applicant: Wal-Mart Stores, Inc., Bentonville, AR (US)

(72) Inventor: Daniel B. Howell, Bentonville, AR (US)

(21) Appl. No.: 15/540,856

(22) PCT Filed: Dec. 29, 2015
(86) PCT No.: PCT/US15/67858

§ 371 Date: Jun. 29, 2017

Related U.S. Application Data
(60) Provisional application No. 62/098,903, filed on Dec. 31, 2014.

(51) Int. Cl. G06Q 30/06; G06Q 10/08; G06K 7/10

(52) U.S. Cl. CPC G06Q 30/0627; G06Q 30/0631; G06Q 10/087; G06K 7/10861

(57) ABSTRACT

An apparatus for providing perishable product freshness information is provided. The apparatus includes a portable device having an input device for receiving a product identifier associated with a perishable product, a sensor reader for receiving data from one or more sensors in proximity of the perishable product and the portable device, a display device to display information, and a control circuit. The control circuit is configured to: receive the product identifier associated with the perishable product, retrieve a list of one or more external sensors to detect, cause the sensor reader to scan for data from the one or more external sensors, receive detected sensor data from one or more sensors detected by the sensor reader, and cause the display device to display information associated with product freshness determined based on the stored sensor data and a sensor data history associated with the perishable product.

### RELATED APPLICATION(S)

This application claims the benefit of U.S. Provisional Application No. 62/098,903, filed Dec. 31, 2014, which is incorporated by reference in its entirety.

### TECHNICAL FIELD

This invention relates generally to retail sales and perishable products.

### BACKGROUND

Fresh products posses a special challenge to grocery supply and retail management due to their perishable nature. Many factors throughout a product's supply, distribution, and retail stages can affect the freshness of the product when it arrives in the hands of a customer. Access to accurate freshness information can reduce waste and improve efficiency of a retail operation as well as improve a customer's experience with the perishable product.

### BRIEF DESCRIPTION OF THE DRAWINGS

Disclosed herein are embodiments of system, method and apparatuses for providing freshness information. This description includes drawings, wherein:

FIG. 1 is a diagram of a system in accordance with several embodiments.

FIG. 2 is a block diagram of a system in accordance with several embodiments.

FIG. 3 is a flow diagram of a general process in accordance with several embodiments.

FIG. 4 is a diagram of a process in accordance with several embodiments.

FIG. 5 includes illustrations of screenshots in accordance with several embodiments.

Elements in the features are illustrated for simplicity and clarity and have not necessarily been drawn to scale. For example, the dimensions and/or relative positioning of some of the elements in the figures may be exaggerated relative to other elements to help improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for providing freshness information of perishable products on portable devices.

Embodiments of the disclosed system utilize portable devices to gather sensor data and display information on the freshness of perishable product. The portable device may be configured to determine which sensors to detect and only gather data from the relevant sensors based on context information of the portable device and/or the product being monitored. The gathered sensor data forms part of the product's environmental condition history that can be recorded and analyzed to estimate the lifespan and ripeness of the product. Embodiments of the disclosed system and method allow a portable device to easily adapt to a large number of different combinations of sensors, the availability of which often vary throughout a product's supply, distribution, and retail chains, as well as by location and product type. As such, the same device and/or the same software application may be used in a variety of settings with minimal user intervention. Embodiments of the disclosed system further increase the speed and efficiency of a portable device's sensor data collection process.

In general terms, some embodiments provide a system for providing freshness information on a portable device. An apparatus for providing perishable product freshness information includes a portable device to be used by a user. The portable device includes an input device for receiving a product identifier associated with a perishable product, a sensor reader for receiving data from one or more sensors in proximity of the perishable product and the portable device, a display device to display information to the user of the portable device, and a control circuit coupled to the input device, the sensor reader, and the display device. The control circuit is configured to: receive the product identifier associated with the perishable product via the input device, retrieve a list of one or more external sensors to detect, cause the sensor reader to scan for data from the one or more external sensors, receive detected sensor data from one or more sensors detected by the sensor reader, and cause the display device to display information associated with product freshness determined based on the stored sensor data and a sensor data history associated with the perishable product.

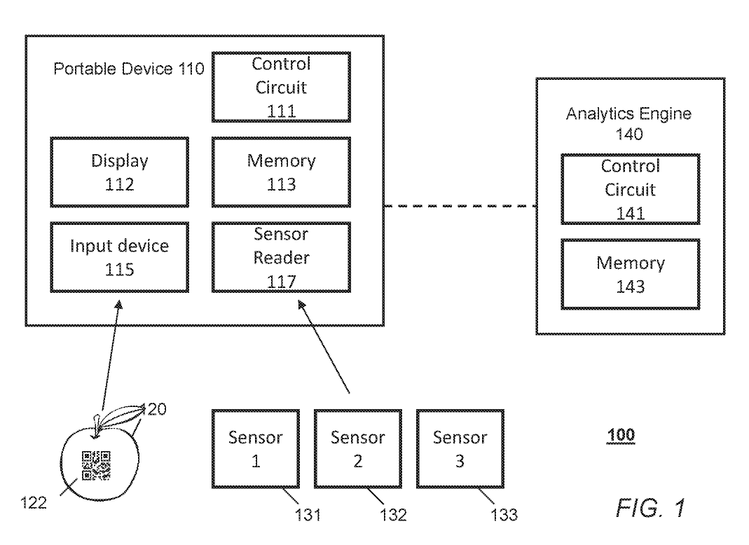

Referring now to FIG. 1, a system for providing freshness information is shown. The system 100 includes a portable device 110, sensors 131, 132, 133 monitoring a perishable product 120, and an analytics engine 140.

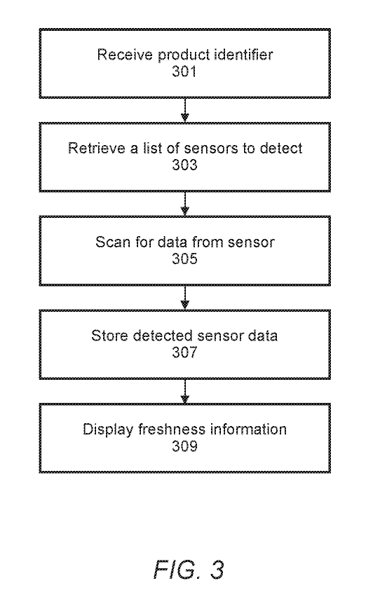

The portable device 110 includes a control circuit 111, a display device 112, memory device 113, an input device 115, and a sensor reader 117. The portable device 110 may be any portable processor based device such as a smart phone, a tablet computer, a laptop computer, a hand-held device, a wearable device, and the like. In some embodiments, the portable device 110 may have stored in its memory device 113, a freshness information application that is executable by the control circuit 111. The application may be include user interfaces specifically for supply chain workers, sales associates in retail stores, and/or customers providing different types of information. The application may be configured to receive a product identifier, retrieve a list of sensors to detect, scan for available sensors based on the list, collect sensor data, and display information associated with freshness of the product via a user interface of the application displayed on the display device 112. A detail description of the data collection process is provided herein with reference to FIG. 3 below.

The input device 115 is configured to obtain product identifying information from a perishable product 120. In some embodiments, the input device 115 may be a barcode scanner, a quick response (QR) code scanner, a radio frequency identification (RFID) tag receiver, a near field communication (NEC) tag receiver, a Bluetooth low energy receiver, a camera, and the like. In some embodiments, the input device 115 may be a touch screen configured to read a capacitive ink label of the perishable product 120 to receive the product identifier. In some embodiments, the user may enter product identifying information manually via the user interface. Product identifying information may refer to information that identifies the product by product type (Gala apple, Concord grape, etc.), by batch (lot number, box number, pallet number, etc.), and/or by specific item such as a unique serial number. In some embodiments, the input device 115 may include a number of input devices for receiving different types of product identifiers.

The sensor reader 117 is configured to read data from one or more sensors 131, 132, and 133 in proximity of the portable device 110. The sensor reader 117 may be one or more of a short range frequency band receiver, a radio frequency identification (RFID) tag receiver, a near field communication (NEC) tag receiver, a Bluetooth low energy receiver, a camera, and the like. In some embodiments, the sensor reader 117 may include a number of reader devices for obtaining data from different types of sensors. While the input device 115 and the sensor reader 117 are shown as separate elements in FIG. 1, in some embodiments, the input device 115 and the sensor reader 117 may be implemented with the same device or same set of devices. In some embodiments, the input device 115 and the sensor reader 117 are implemented by different devices configured to receive data through different communication channels. Generally, the input device 115 and the sensor reader 117 may be any short-range frequency band and/or optical receiver and/or transceiver. In some embodiments, the input device 115 and the sensor reader 117 include existing components of a portable device 110. In some embodiments, the input device 115 and the sensor reader 117 may be one or more attachments to the portable device 110.

In some embodiments, the portable device 110 may further include other components such as a global positioning system (GPS) sensor and one or more network adapter such as a mobile network transceiver and a WiFi transceiver. For example, a GPS receiver and/or a data network receiver may provide signals for determining the location of the portable device 110 to provide context information to determine which sensors to detect. The portable device 110 may communicate with the analytics engine 140 over a network such as the Internet and/or a local area network via a wireless transceiver.

The perishable product 120, while shown as an apple in FIG. 1, may be any perishable item such as produce, dairy, meat, seafood, plant, floral, deli, prepared meals and bakery goods. The product identifier 122 is configured provides product identifying information to the input device 115 of the portable device 110. The product identifier 122 may include one or more of a barcode, a quick response (QR) code, a radio frequency identification (RFID) tag, a near field communication (NFC) tag, and a Bluetooth low energy transmitter. In some embodiments, the product identifier 122 may be a capacitive ink label readable by a capacitive touch screen. While the product identifier 122 is shown to be affixed to the perishable product 120 in FIG. 1, the product identifier 122 may be attached or integrated to the product's packaging, container, display stand, store signage, and the like. In some embodiments, the portable device 110 may be configured to identify the product with image recognition, and the appearance of the perishable product 120 and/or its packaging may be considered the product identifier.

The sensors 131, 132, and 133 may be sensors situated in proximity of the perishable product 120. In some embodiments, the sensors are attached to or integrated with cases, flats, pallets, or other containers. The sensors 131, 132, and 133 may include one or more of a temperature sensor, a moisture sensor, a gas emission sensor, a light sensor, and the like. In some embodiments, the sensors 131, 132, and 133, may include one or more color or pattern changing sensor that is readable by an image sensor such as a camera. The sensors may be external and separate from the portable device 110. Generally, the sensors may include simple sensors that require low or no power to operate. The sensors are generally situated near one or more perishable products being monitored and configured to provide sensor data to portable device in proximity of the perishable product. In some embodiments, one or more of the sensors 131, 132, and 133 constantly broadcasts sensor data. In some embodiments, the sensors have a wake-up type transmitter that only takes measurement and/or sends out sensor data when it receives a request from the portable device 110. The sensors 131, 132, and 133 may be the same or different types of sensors. While only three sensors are shown, it is understood that there may be any number of sensors in proximity of a perishable product 120. There may also be sensors that are not monitoring the environment associated with the perishable product 120 which are detectable by the portable device 110 when the portable device 110 is in proximity of the perishable product 120. The portable device 110 may be configured to determine which sensors to detect based on the product identifier 122 and/or other context information. For example, after receiving the product identifier 122, the portable device may retrieve a list of sensors that are relevant and/or present, and scan for those sensors. The detailed description of the sensor selection process is described herein in more detail with reference to FIG. 3 below.

The analytics engine 140 may be any network accessible processor based device such as a remote, web-based, and/or cloud based server. In some embodiments, the functions of the analytics engine may be implemented by multiple physical devices. The analytics engine 140 includes a control circuit 141 and a memory device 143. The memory device 143 may record environmental condition histories for a number of products tracked by the engine. When the analytics engine 140 receives sensor data from the portable device 110, it may combine it with the product's environmental conditions history and determine information associated with the product's freshness. For example, the information may include a sell-by date, an estimated expiration date, and/or a stage of ripeness. In some embodiments, the information associated with product freshness comprises a task to be performed by a sales associate such as: place the perishable product on a sales floor, relocate the perishable product, remove the perishable product from sales, move the perishable product into climate controlled storage, apply a discount to the perishable product, and the like. In some embodiments, the information associated with product freshness comprises a recommendation a consumer such as: a best-by date, available discounts, and a suggest recipe, a suggested use of the perishable product based on the perishable product's current freshness, and the like. In some embodiments, the analytics engine determines information regarding the ripeness or freshness left on an item based on predictive comparisons of other similar items. In some embodiments, the analytics engine may use any known methods to determine the estimated expiration date and/or stage of freshness.

In some embodiments, the analytics engine 140 or another server device further includes a sensor database. The sensor database may store lists of sensors associated with location and/or product type. For example, a list of data may be associated with potatoes, store #45, potatoes at store #45, etc. Detail descriptions of sensor lists are provided herein with reference to FIG. 3 below.

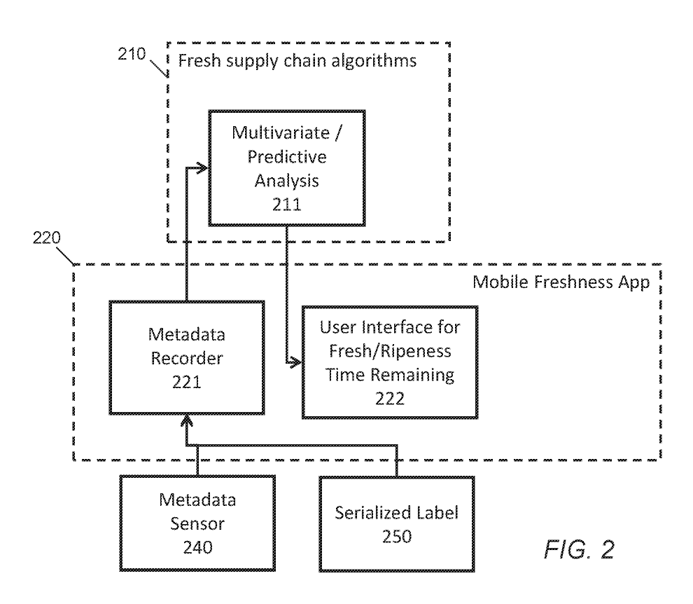

Referring now to FIG. 2, a block diagram for providing freshness information is shown. The process shown in FIG. 2 may be performed by the system shown in FIG. 1 or any system including one or more control circuits, such as computing devices, processor-based devices, and the like. The process includes a fresh supply chain algorithms portion 210 and a mobile freshness application portion 220. In the mobile freshness application portion 220, a metadata recorder module 221 determines which sensors to detect and scan for data from the metadata sensor 240. The metadata recorder module 221 further receives a serialized label 250 associated with a perishable product. The metadata recorder module 221 then provides the sensor data and the product identifier to the multivariate/predictive analysis module 211 of the fresh supply chain algorithms portion 210 for analysis. The multivariate/predictive analysis module 211 then provides information associated with product freshness to the user interface module 222 to display freshness, ripeness, and/or time remaining information to a user. In some embodiments, the displayed information may be based on whether the user is a worker in the supply and distribution chain or a customer. For example, information displayed to sales associates in a retail location may include action items such as: place the perishable product on a sales floor, relocate the perishable product, remove the perishable product from sales, move the perishable product into climate controlled storage, and apply a discount to the perishable product. Information displayed to customer may include a best-by date and a suggest use of the perishable product based on the perishable product's current freshness. The user interface may further provide options for the customer to access a recipe suitable for the product's freshness, add the product to a virtual shopping cart, and/or initiate a check out process.

The fresh supply chain algorithms portion 210 may be implemented on one or more of a mobile device, a local computing device, a retail store computing device, a cloud-based server, and the like. The mobile freshness application 220 portion may be implemented on any portable device such as a smart phone, a tablet computer, a laptop computer, a hand-held device, a wearable device, and the like. The metadata sensor 240 may be one or more sensors situated in proximity of the perishable product. In some embodiments, the metadata sensor 240 are attached to or integrated with cases, flats, pallets, or other containers. The serialized label 250 may be attached to or integrated with the product, product's packaging, container, display stand, store signage, and the like. The modules described herein may be implemented as software and/or hardware modules.

Now referring to FIG. 3, a method for providing freshness information is shown. The process shown in FIG. 3 may be performed by the system shown in FIG. 1 or any system including one or more control circuits, such as computing devices, processor-based devices, and the like. In some embodiments, the method shown in FIG. 3 may be performed by a portable device such as a smart phone, a tablet computer, a laptop computer, a hand-held device, a wearable device, and the like.

In step 301, the portable device receives a product identifier. The product identifier may be received via a input device such as a barcode scanner, a quick response (QR) code scanner, a radio frequency identification (RFID) tag receiver, a near field communication (NFC) tag receiver, a Bluetooth low energy receiver, and a camera. The product identifier may be one or more of a barcode, a quick response (QR) code, a radio frequency identification (RFID) tag, a near field communication (NFC) tag, and a Bluetooth low energy transmitter associated with a perishable product. In some embodiments, the product identifier is received via a touch screen of the portable device reading a conductive ink label of the perishable product. In some embodiments, the product identifier may be entered manually by a user or be based on image recognition. The product identifier may be unique to the specific product or may represent a batch of products.

In step 303, the portable device retrieves a list of sensors to detect. The list of sensors may be retrieved from the portable device's internal memory or from an external server. The list of sensors to detect may be determined or selected based on the context of the portable device and/or the perishable product. The context may be associated with the type of product and/or the location of the portable device and/or product. For example, the device may determine whether it is at a private residence, a retail store, a storage facility, a transportation vehicle, a farm, etc. based on the device's location and/or movement. Based on this location information, the device may retrieve a list of sensors that are likely to be to known to be available in such locations. For example, while storage facilities are likely to have moisture sensors, a private residence would not. The list can further be based on specific location's information. For example, a database may store available sensors information for a number of retail stores and/or storage facilities, and the sensors known to be present in specific stores and facilities are used to form the list of sensors to detect. In some embodiments, the list of sensors may be based on the type of product being monitored. For example, potatoes are not particularly sensitive to temperature. If the portable device receives a product identifier in step 301 that is associated with a potato, the list of sensors may omit temperature sensors even if temperature sensors are known to be present at the device's location. In some embodiments, the list of sensors is configured to identify sensors that are relevant to the environment of the particular perishable product. For example, on a retail floor, there may be temperature sensors inside freezer units, refrigerated units, and room temperature areas. If the product identifier received in 301 is associated with ice cream, the list of sensors may only include the temperature sensor that is monitoring the freezer. If the product is milk, the list of sensors may only include the refrigerator temperature sensor. In another example, separate gas sensors monitoring apples, bananas, and grapes may all be in proximity of a portable device. The list of sensors may tell the portable device which gas sensor is associated with the product identified in step 301. In some embodiments, list of sensors is determined based on both location information and the product information. In some embodiments, a sensor information database may include lists of sensors associated with locations and/or product types. In some embodiments, the portable device retrieves the product identifier and/or portable device location information to a server, and the server provides the portable device a list of sensors to scan for. In some embodiments, the portable device is configured to select a list of sensors based on its context information and/or the product identified in step 301.

In step 305, the portable device scans for data from sensors specified in the list of sensors retrieved in step 303. The portal device may be configured and/or situated to read from tens or hundreds of sensors. However, with a narrowed list of sensors to detect, the data gathering step can be made significantly more efficient by reducing the number of sensors the device needs to detect from all discoverable sensors to only the relevant sensors. The list of sensors may further provide information regarding the communication means associated each sensor on the list. For example, the list of sensors may specify a temperature sensor communicating via RFID and a moisture sensor communicating via low energy Bluetooth. The portable device may selectively turn on the relevant receivers on to read temperature and moisture data and ignore signals received from other means of communication. In some embodiments, the list of sensors may indicate which sensors are wake-up type sensors, and instruct the portable device to send the appropriate wake-up signal. In some embodiments, the sensor list may provide sensor identifying information. For example, the portable device may detect or “see” several sensors sending out data via low energy Bluetooth but is able to select the relevant sensors based on the sensor IDs in the sensor list to pair and/or receive data from the selected sensors. In some embodiments, the list of sensors may provide information needed to receive data from the sensors, such decryption key, transmission frequency, sensor ID, etc. In some embodiments, the list of sensor provides general information on sensor type. In some embodiments, the list of sensors uniquely identifies specific sensors to detect with sensor identifying information.

In some embodiments, after step 305, the portable device may prompt the user to collect more sensor data based on the sensor list. For example, if the sensor list includes a color or pattern changing label and the camera of the portable device do not see the label in its current view, the portable device may prompt the user to look for and scan the label.

In step 307, the detected sensor data is stored. In some embodiments, the process proceeds from step 305 to step 307 even when not all sensors on the sensor list are detected after a certain time period, such as, 5 seconds or 10 seconds. In some embodiments, some sensors on the list may be marked as optional and may be omitted if not found within a short period time. The data collected from the detected sensors may first be stored locally and then provided to a remote server for analysis. The server may combine the sensor data gathered by the portable device with an environmental condition history associated with the product identified by the product identifier received in step 301 to determine information associated with the freshness of the product. The estimated expiration date, ripeness, best-by date, etc. may be determined by either the server or the portable device based on known methods. In some embodiments, if not environmental condition history exists for a particular product, the system may be configured to provide freshness information based solely on comparative analysis with other like products.

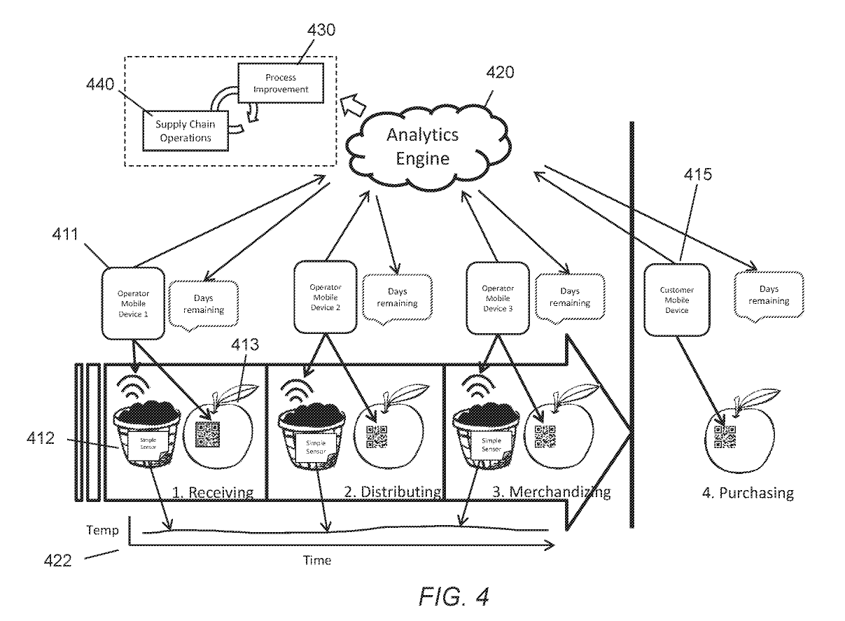

In step 309, the portable device displays information associated with the freshness of the product to the user. In some embodiments, the displayed information may be based on whether the user is a worker in the supply and distribution chain or a customer. For example, information displayed to sales associates in a retail location may include action items such as: place the perishable product on a sales floor, relocate the perishable product, remove the perishable product from sales, move the perishable product into climate controlled storage, apply a discount to the perishable product, and the like. Information displayed to customer may include recommendations such as: a best-by date and a suggest use of the perishable product based on the perishable product's current freshness. The information screen may further provide the option for the customer to access a recipe suitable for the product's freshness, add the product to a virtual shopping cart, and/or initiate a check out process. The displayed information may be determined by a remote analytics engine or determined locally by the application running on the portable device based freshness data provided by the remote analytics engine. In some embodiments, even if no sensor data is gathers, the portable may still display information about the product's freshness based on the existing environmental conditions history and/or inferred environmental condition. The method shown in FIG. 3 may be perform at any stage during the supply, distribution, and retail process of perishable products as described below with reference to FIG. 4.

Now referring to FIG. 4, a diagram showing the tracking of a product's environmental condition history is shown. During each of the receiving, distributing, and merchandising stages, an operator mobile device 411 may gather data from simple sensor(s) and product identifiers 413 and provide that information to an analytics engine 420. The analytics engine 420 stores the sensor data history 422 through out each stage. The analytics engine may further provide “days remaining” and other freshness related information, such as recommended actions, to the operator mobile devices 411. During the purchasing stage, a consumer mobile device 415 may read a product identifier and receive days remaining information and other freshness related information determined based on the sensor data history 422 maintained by the analytics engine 420. In some embodiments, during the purchasing stage, the consumer mobile device may also be configured to collect data form sensors and add that information to the sensor data history 422 to increase the accuracy of the estimated freshness. For example, after a consumer purchased a perishable product, the consumer may place the product in a smart refrigerator that is able to provide environmental condition data such as temperature and/or moisture measurements to the consumer mobile device 415 and/or to the analytics engine 420. The data gathered by the sensors of the smart refrigerator may be added to the sensor data history 422. While the sensor data history 422 is shown as a temperature over time graph, the analytics engine 420 may maintain and analyze data history from any type of sensors such as a moisture sensor, a gas emission sensor, and a light sensor. The analytics engine 420 may further provide the collected sensor readings as data for process improvement 430 and supply chain operations 440. For example, the collected data may help the supply chain the condition best suited for maintaining freshness for the longest period of time to reduce waste due to spoilage.

At each of the receiving, distribution, merchandizing, and purchasing stage, the mobile devices 411 and 415 and/or the analytics engine may be able to determine which sensors are relevant and/or present based on the location of the product and/or the type of product being monitored. While different individuals, companies, and facilities may be involved in each of the stages shown in FIG. 4, the application running on the mobile devices allows the mobile device to adapt to different combinations of available sensors in different settings without sacrificing efficiency. The system further allows sensor data at each stage to be gathered with the same software application and added to a central database regardless the variations of sensor setup at each stage/location.

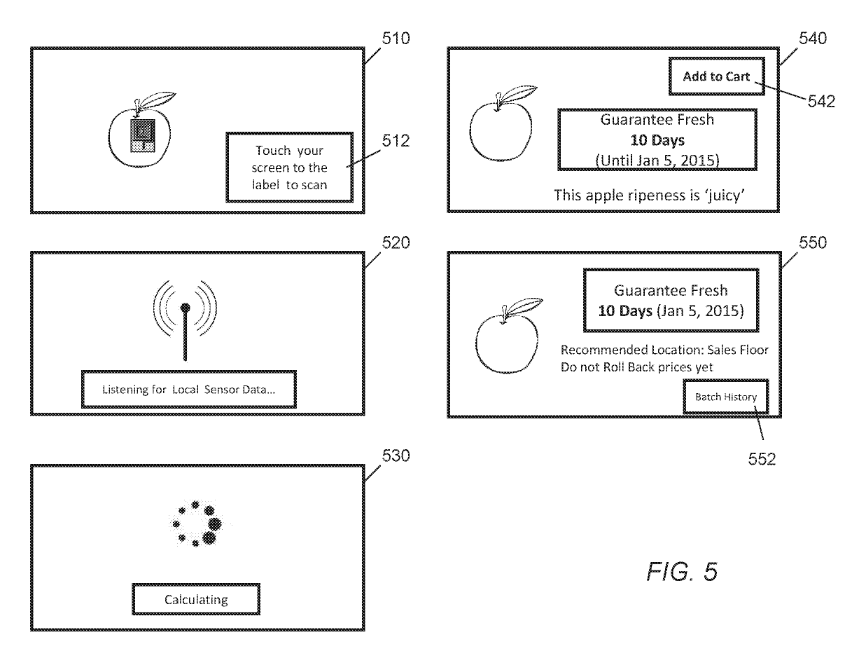

Now referring to FIG. 5, illustrations of screen shots of a user interface of an application for providing freshness information is shown. In screen 510, the customer is instructed to obtain a product's product identifier. For example, in screen 510, the user is given the instruction 512 “touch your screen to the label to scan” for a product having a capacitive ink label. After screen 510, the device retrieves a list of sensors to detect. In screen 520, the user interface notifies the user that it is “listening for local sensor data.” By narrowing the list of sensors to detect by product type and/or location, the “listening” time for the portable device can be considerably shortened. After the sensor data are gathered, the sensor data are provided to an analytics engine for analysis. In screen 530, the user interface indicates to the user that the system is calculating freshness related information. The calculation may be performed at the portable device to by a remote server. In some embodiments, screen 520 and 530 may be optional, and screen 540 or screen 550 may be displayed when freshness is available for display.

Screen 540 illustrates a freshness information screen for a customer. The screen may provide the “guarantee fresh” days information on the product (10 days left in this case) and may provide additional descriptions such as “this apple ripeness is ‘juicy’” as shown, or “this apple is crispy,” etc. based on freshness/ripeness information estimated by a server. The freshness information screen may also include suggested use (“this avocado is just ripe for making guacamole,” “this apple is perfect for making apple pie” etc.), suggested recipes (guacamole recipe, apple pie recipe etc.), and available discount (20% off, etc.). The screen may provide other functions to the customer such as an option to “add to cart” 542 for check out and/or initiate checkout.

Screen 550 illustrates a freshness information screen for a supply, distribution, and/or retail chain worker. In addition to the number of fresh days remaining, the screen 550 may further include recommended/required action. For example, “recommended location: sales floor, do not roll back prices yet.” Other actions include place the perishable product on a sales floor, relocate the perishable product, remove the perishable product from sales, move the perishable product into climate controlled storage, apply a discount to the perishable product, etc. The recommended/required action may be further integrated with a task management system of the storage, transportation and/or retail operation. Screen 550 may further provide access to more detailed information on the product. For example, the user may be able to view batch 552 information which may include sensor data history related to the batch and/or inventory information for the batch of product.

Screens 510, 520, 530, 540, and 550 are provided as examples only. An application can provide similar functionalities and information with other user interface displays and designs without departing from the spirit of the present disclosure.

In some embodiments, an apparatus for providing freshness information on a portable device is provided. An apparatus for providing perishable product freshness information includes a portable device to be used by a user. The portable device includes an input device for receiving a product identifier associated with a perishable product, a sensor reader for receiving data from one or more sensors in proximity of the perishable product and the portable device, a display device to display information to the user of the portable device, and a control circuit coupled to the input device, the sensor reader and the display device. The control circuit is configured to: receive the product identifier associated with the perishable product via the input device, retrieve a list of one or more external sensors to detect, cause the sensor reader to scan for data from the one or more external sensors, receive detected sensor data from one or more sensors detected by the sensor reader, and cause the display device to display information associated with product freshness determined based on the stored sensor data and a sensor data history associated with the perishable product.

In some embodiments, a method for providing information on perishable product freshness is provided. The method includes: receiving, by an input device of a portable device, a product identifier associated with a perishable product, retrieving a list of one or more external sensors to detect, scanning, with a sensor reader of the portable device, for data from the one or more external sensors in proximity of the perishable product and the portable device, storing detected sensor data from one or more sensors detected by the sensor reader; and displaying, on a user display of the portable device, information associated with product freshness based on the detected sensor data and a sensor data history associated with the perishable product.

In some embodiments a system for providing perishable product freshness information is provided. The system includes one or more sensors situated in proximity of a perishable product having a product identifier readable by a portable device to provide the portable device a list of sensors to detect, the one or more sensors being configured to provide sensor data to the portable device in proximity of the perishable product, a memory device storing sensor data histories for a plurality of products; and a control circuit coupled to the memory device. The control circuit is configured to: receive the sensor data and the product identifier from the portable device, retrieve a sensor data history associated with the product identifier, and cause information associated with product freshness determined based on the sensor data and the sensor data history associated with the perishable product to be displayed on the portable device.

In some embodiments, a method for determining perishable product freshness is provided. The method includes: receiving a product identifier associated with a perishable product, retrieving a list of one or more sensors to detect, causing a sensor reader to scan for data from the one or more sensors, storing detected sensor data from one or more sensors detected by the sensor reader, and generating, for display, information associated with product freshness based on the sensor data detected by the sensor reader and a sensor data history associated with the perishable product.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An apparatus for providing perishable product freshness information comprising:
a portable device to be used by a user comprising:
an input device for receiving a product identifier associated with a perishable product;
a sensor reader for receiving data from one or more sensors in proximity of the perishable product and the portable device;
a display device to display information to the user of the portable device;
a control circuit coupled to the input device, the sensor reader, and the display device and configured to:
receive the product identifier associated with the perishable product via the input device;
retrieve a list of one or more external sensors to detect;
cause the sensor reader to scan for data from the one or more external sensors;
receive detected sensor data from one or more sensors detected by the sensor reader; and
cause the display device to display information associated with product freshness determined based on the stored sensor data and a sensor data history associated with the perishable product.

2. The apparatus of claim 1, wherein the perishable product comprises one or more of produce, dairy, meat, seafood, plant, floral, deli, prepared meals and bakery goods.

3. The apparatus of claim 1, wherein the input device comprises one or more of: a barcode scanner, a quick response (QR) code scanner, a radio frequency identification (RFID) tag receiver, a near field communication (NFC) tag receiver, a Bluetooth low energy receiver, and a camera.

4. The apparatus of claim 1, wherein the input device comprises a touch screen configured to read a capacitive ink label of the perishable product to receive the product identifier.

5. The apparatus of claim 1, wherein the one or more sensors comprise one or more of: a temperature sensor, a moisture sensor, a gas emission sensor, and a light sensor.

6. The apparatus of claim 1, wherein the control circuit is further configured to:
determine a context for one of the portable device and the perishable product,
wherein the list of the one or more external sensors to detect is retrieved based on the context.

7. The apparatus of claim 6, wherein the context comprises a portable device location determined based on one or more of a global positioning system (GPS) sensor, a mobile network transceiver, and a WiFi transceiver of the portable device.

8. The apparatus of claim 6, wherein the context is determined based on the product identifier and the list of one or more external sensors is associated with the product identifier.

9. The apparatus of claim 1, wherein the information associated with product freshness comprises a task to be performed by a sales associate comprising one or more of: place the perishable product on a sales floor, relocate the perishable product, remove the perishable product from sales, move the perishable product into climate controlled storage, and apply a discount to the perishable product.

10. The apparatus of claim 1, wherein the information associated with product freshness comprises a information to a consumer comprising one or more of: a best-by date, available discounts, and a suggest recipe, and a suggested use of the perishable product based on the perishable product's current freshness.

11. The apparatus of claim 1, wherein the sensor reader comprises one or more of: a short range frequency band receiver, a radio frequency identification (RFID) tag receiver, a near field communication (NFC) tag receiver, a Bluetooth low energy receiver, and a camera.

12. A method for providing information on perishable product freshness comprising:
receiving, by an input device of a portable device, a product identifier associated with a perishable product;
retrieving a list of one or more external sensors to detect;
scanning, with a sensor reader of the portable device, for data from the one or more external sensors in proximity of the perishable product and the portable device;
storing detected sensor data from one or more sensors detected by the sensor reader; and
displaying, on a user display of the portable device, information associated with product freshness based on detected sensor data and a sensor data history associated with the perishable product.

13. The method of claim 12, wherein the perishable product comprises one or more of produce, dairy, meat, seafood, plant, floral, deli, prepared meals and bakery goods.

14. The method of claim 12, wherein receiving the product identifier comprises the portable device reading one or more of: a barcode, a quick response (QR) code, a radio frequency identification (RFID) tag, a near field communication (NFC) tag, and a Bluetooth low energy transmitter.

15. The method of claim 12, wherein the product identifier is received via a touch screen of the portable device reading a conductive ink label of the perishable product.

16. The method of claim 12, wherein the one or more sensors comprise one or more of: a temperature sensor, a moisture sensor, a gas emission sensor, and a light sensor.

17. The method of claim 12, further comprising:
determining a context for one of the portable device and the perishable product, wherein the list of the one or more external sensors to detect is retrieved based on the context.

18. The method of claim 17, wherein the context comprises portable device location determined based on a signal from one or more a global positioning system (GPS) sensor, a mobile network transceiver, and a WiFi transceiver of the portable device.

19. The method of claim 17, wherein the context is determined based on the product identifier and the list of one or more external sensors is associated with the product identifier.

20. The method of claim 12, wherein the information associated with product freshness comprises a task to be performed by a sales associate comprising one or more of: place the perishable product on a sales floor, relocate the perishable product, remove the perishable product from sales, move the perishable product into climate controlled storage, and apply a discount to the perishable product.

21. The method of claim 12, wherein the information associated with product freshness comprises a recommendation to a consumer comprising one or more of: a best-by date and a suggest use of the perishable product based on the perishable product's current freshness.

22. The method of claim 12, wherein the sensor reader comprises one or more of: a short range frequency band receiver, a radio frequency identification (RFID) tag receiver, a near field communication (NFC) tag receiver, a Bluetooth low energy receiver, and a camera.

23. A system for providing perishable product freshness information comprising:
one or more sensors situated in proximity of a perishable product having a product identifier readable by a portable device to provide the portable device a list of sensors to detect, the one or more sensors being configured to provide sensor data to the portable device in proximity of the perishable product;
a memory device storing sensor data histories for a plurality of products; and
a control circuit coupled to the memory device and configured to:
receive the sensor data and the product identifier from the portable device;
retrieve a sensor data history associated with the product identifier; and
cause information associated with product freshness determined based on the sensor data and the sensor data history associated with the perishable product to be displayed on the portable device.

24. A method for determining perishable product freshness comprising:
receiving a product identifier associated with a perishable product;
retrieving a list of one or more sensors to detect;
causing a sensor reader to scan for data from the one or more sensors;
storing detected sensor data from one or more sensors detected by the sensor reader; and
generating, for display, information associated with product freshness based on sensor data detected by the sensor reader and a sensor data history associated with the perishable product.
